(19) United States
(12) Patent Application Publication
(10) Pub. No.: US 2014/0290660 A1
(43) Pub. Date: Oct. 2, 2014

(54) Harleyhex Carbon Dioxide Balanced Foldable Respiratory Treatment Chamber

(71) Applicants: Tricia Helen Blair, Naples, FL (US); Barbara Ann Killian, Naples, FL (US)

(72) Inventors: Tricia Helen Blair, Naples, FL (US); Barbara Ann Killian, Naples, FL (US)

(21) Appl. No.: 13/855,656

(22) Filed: Apr. 2, 2013

(51) Int. Cl. A61G 10/02

(52) U.S. Cl. CPC A61G 10/023
USPC 128/205.26

(57) ABSTRACT

One embodiment of a collapsible chamber that is used to house a small animal while administering respiratory medications prescribed by Veterinarians that allows atmospheric air to flow in and carbon dioxide to flow out while the animal is receiving respiratory treatment. The chamber: maintains a medically sanitary environment; keeps the animal calm during treatment thus maximizing the amount of medication delivered; becomes foldable, thus portable for mobile treatment or storage; uses standard tubing and connectors for nebulizer, oxygen and other gaseous types of medication delivery systems. One embodiment of a chamber comprised of transparent panels, edging, and screws. Other embodiments are described and shown.

### CROSS-REFERENCE TO RELATED APPLICATIONS

This application claims the benefit of provisional patent application No. 61/638,763, filed 2012 Apr. 26 by the present inventors.

### BACKGROUND

Respiratory disease in small animals is becoming more and more prevalent in today's environment. In both dogs and cats environmental factors are causing many respiratory diseases and illnesses. In addition, respiratory illnesses are more wide-spread when animals are housed closely together in the household or in kennels. Small animals are susceptible to respiratory illness summarized as “Respiratory disease complex” in both cats and dogs. Respiratory disease complex is typically caused by contagious and non-contagious viral and bacterial pathogens. Feline herpes virus and feline caliciviviris are the common viral infections in cats. Symptoms of these viruses are observed as ocular, nasal and oral discharge. Canine respiratory illnesses are also very prevalent. Bordetella bronchiseptica is the most common bacterial pathogen causing canine upper respiratory tract infection. Viral-based infections are also prevalent in canine respiratory illnesses having similar symptoms as in feline cases.

Veterinary methods to combat or control these illnesses are in place which uses a variety of methods. One method used is to employ the use of various animal health or human pharmaceutical medication via orally, or nebulizing directly to the animal's lungs, or both. In particular, the use of nebulization therapy has become a common delivery system in the treatment of respiratory illnesses. Nebulizers and Meter Dose Inhalants are the common methods used by Veterinarians for animal nebulization respiratory treatment. In the case where nebulizers are used, Veterinarian prescribed medication is placed into a nebulizer cup or reservoir. One end the cup is attached to a nebulizer pump, using a standard 7 foot tube, which transforms the medication into a mist. A mouthpiece is connected on the other end of the cup which the animal or patient uses to breathe in the medicated mist. In the case of animals, this end is modified into a mouthpiece or mask that covers both the nose and mouth. This is performed so the animal will breathe in the medication as thoroughly as possible to obtain the appropriate medication. One major drawback to this method is that it is difficult to hold an animal in the same position for the length of the treatment time. Treatment times vary however typically for the above mentioned illnesses each treatment is approximately 20 to 30 minutes at one given time. Having to hold the animal in place for this length of time causes the animal to become scared and stressed, thus causing labored breathing which minimizes the effectiveness of the animal receiving medication.

Another method used by Veterinarians for animal respiratory treatment is the use of a respiratory chamber. Chambers are most effective since the animal is placed in a confined area and can receive the prescribed amount of treatment in the prescribed amount of time more easily. There is no need to hold the animal in place for treatment. Standard nebulizer tubes are available to introduce the nebulizer cup to the chamber, thus to introduce the medicated mist into the chamber for the animal to breathe into its lungs.

Although using a chamber has the above benefit, it has drawbacks. Chambers can be bulky and take up space. They can be made of materials, such as metal, wood or fabric that react with medications, thus introducing trace elements that can cause toxins to be introduced into the animal's lungs. They may not allow the carbon dioxide produced by the animal's exhalation to be eliminated from the confined environment. They can be made of materials that are non-transparent so the animal cannot see its surrounding which causes stress, thus causing the animal to breathe laboriously which interferes with the respiratory treatment. They can be made of materials that cannot be sanitized. In addition, they can be made of materials that are very expensive, such as stainless steel.

This provisional patent (61/638,763, filed 2012 Apr. 26), claims to be the first foldable, carbon dioxide balanced, see-through, respiratory treatment chamber for small animals that uses standard tubing for nebulizer or other gaseous-type treatments; can be sanitized; and is affordable. The chamber improves the method of delivering respiratory medications to small animals by placing them in a chamber that allows the free flow of atmospheric air in and the free flow of carbon dioxide out of the chamber, thus creating a safe therapeutic air environment, and thus, increases the medication effectiveness; it uses transparent materials so the animal is less stressed since it can see its surroundings, thus reducing labored breathing so the animal receives as close to its proper prescribed medication dose; it is foldable, thus portable chamber for mobile treatment and storage; it can be sanitized; it is affordable.

Atmospheric air contains approximately 390 ppm by volume of carbon dioxide. Typical room levels are approximately 680 ppm. When animals, or mammals, are in confined spaces, the levels of carbon dioxide increase due to less atmospheric air being introduced into the area compounded by the mammals own elimination of carbon dioxide. Various United States' Health Commissions have determined that carbon dioxide levels of 250-350 ppm are normal outdoor ambient concentrations, levels of 600 ppm produce minimal air quality complaints, 600-2000 ppm being less clearly interpreted and levels above 3000 ppm indicates inadequate ventilation; complaints such as headaches, fatigue, and eye and throat irritation are more widespread; 3000 ppm should be used as an upper limit for indoor levels. In addition, the Occupational Safety and Health Association have determined that carbon dioxide is one of many contaminants in poor air quality. This is due to “improperly vented devices, processes or operations which produce combustion products and human respiration.”

This provisional patent chamber has been designed to create an environment with an average carbon dioxide level of <3000 ppm, with a small animal contained in a confined chamber for the delivery of medications for respiratory therapy used in a room with proper ventilation, and in places that atmospheric room air has a carbon dioxide level of less than 3000 ppm therein contained. Maintaining an environment in which the carbon dioxide does not exceed 3000 ppm is accomplished when the chamber is lifted from its folded state and brought to its cube state. Four edges of the chamber have gaps in them so to allow atmospheric air to naturally flow into the chamber and carbon dioxide produced by the animal to naturally flow out of the chamber. Tests were performed with various gaps and various enclosures on all of the chamber's, or cube edges. A carbon dioxide (CO2) meter was used throughout testing. In a totally enclosed chamber, the CO2 level reached 3000 ppm within three minutes, within a room with atmospheric levels of 680 ppm. Various gaps throughout the chamber were progressively used in order to reach the outcome of the CO2 buildup not to exceed an average of 3000 ppm within a 20 to 30 minute treatment time, in a room of <3000 ppm. The tests performed comprised the use of a 1:9, antibiotic:saline solution. This provisional patent was named after our cat, Harley, who has a feline upper respiratory illness referred to as kitty sniffles in which the herpes virus is present. Harley's veterinarian prescribed medication and treatment process was used in all of the tests. Harley has been on this treatment schedule using this provisional patent chamber for the past year and has improved immensely with his respiratory symptoms. He exudes much less mucus from his nose, has little to no congestion, and has little to no eye mucus. Before Harley's respiratory therapy he produced voluminous amounts of mucus from his nose which was found quite frequently around the house floor, walls and furniture. In addition, he would breathe in a congestive manner and have eye mucus several times per week. This provisional patent was named after Harley and the chamber's hexahedron shape.

The chamber can be made in many various sizes to accommodate the various sizes of small animals. Testing also included a various amount of chamber sizes. It was found that the size of the chamber is in direct proportion of the gap size of four edges of the chamber or cube, producing the same results of CO2 levels being an average of less than 3000 ppm, again, when the chamber is used in a room with atmospheric levels of CO2 that does not exceed 3000 ppm. Results also showed that when the chamber increased in size the average CO2 ppm levels decreased.

It is important to maintain a sanitary environment when delivering respiratory medication to an animal. The provisional patent embodiment is contemplated to be comprised of durable transparent acrylic sides and plastic components that enable the chamber to be sanitized for each treatment; other transparent materials can be used and would be suitable. In addition, for example, acrylic does not absorb liquid or gaseous materials, thus providing maximum delivery of the respiratory medication to the animal. Also, the use of acrylic, or suitable equivalent, does not lead to any chemical or residual chemical reaction to the medication being used for treatment. Any other type of material that does not absorb medication nor react with it can be used and would be suitable.

The transparent nature of the chamber allows the animal to see its surroundings allowing the animal to be in a non-stressful state so the animal breathes in a uniform and non-labored manner in order to receive proper amounts of prescribed medication. Contemplating the use of acrylic or other transparent material as the main component of this invention keeps the cost of the unit at a minimum, unlike stainless steel which is expensive.

### SUMMARY

In accordance to one embodiment a chamber comprised of transparent panels and materials that fold for portability and storage, and fold up to form a cube that allows for the free flow of room air into it and carbon dioxide to flow of out of it; allows standard nebulizers or other respiratory apparatus to connect to it; can be sanitized; allows the animal to see its surroundings; and is affordable.

Accordingly several advantages of one or more aspects are as follows: to provide a small animal respiratory treatment chamber that allows atmospheric air to flow through the chamber and carbon dioxide to flow out of the chamber, thus a small animal contained within receives respiratory treatment within a quality air environment not to cause toxic levels of carbon dioxide buildup; to utilize standard respiratory tubing, standard respiratory delivery systems, and processes; to provide a transparent chamber allowing the animal to see its surroundings and to be in a non-stressful state so it breathes in a uniform and non-labored manner in order to receive Veterinarian prescribed medication; to be sanitized before and after treatments; to not absorb liquid or gaseous materials, and not to react with such materials, thus providing quality delivery of the respiratory medication directly to the animal; to enable the chamber to fold for portability to eliminate hauling a bulky chamber when needing to travel, or for storage; to be easily lifted up from its folded state to its enclosed, chamber state to commence treatment within minutes; to provide an affordable solution for nebulizer or other respiratory apparatus for animals needing respiratory therapy. The chamber can also be used for reptiles, birds or other small animals requiring such treatment.

### DRAWINGS

### Figures

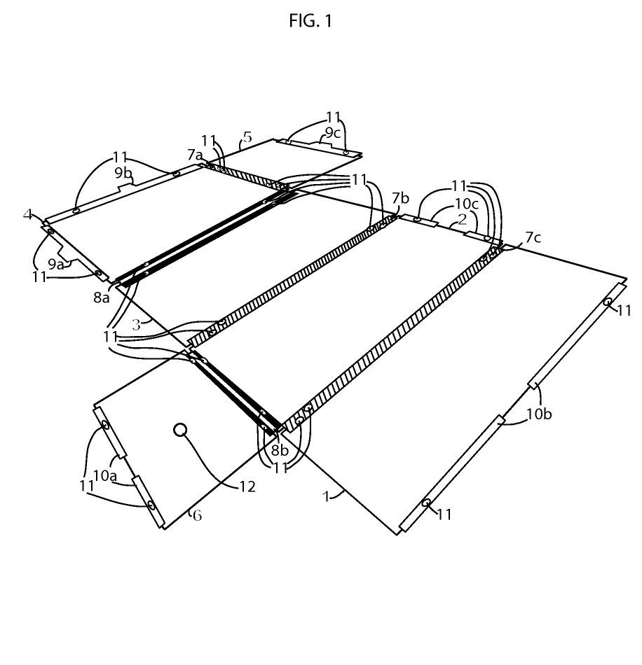

FIG. 1 shows the chamber with all of its sides when unfolded in its linear state. It also shows all of the edging attached to panels. It shows all of the panels that contain latches and all of the panels that contain notches. One panel has an orifice. In addition, it shows screws which connect each edging, and each latch, and each notch to its corresponding panel.

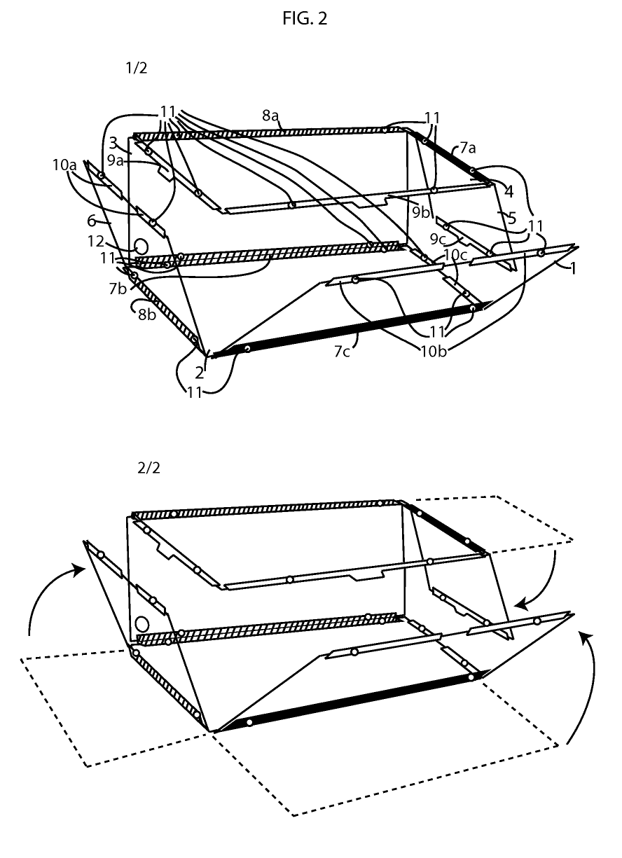

FIG. 2 shows the operation of enclosing the said chamber by bringing together each of the said panels, using the said latch and said notch fitting to secure said chamber in place.

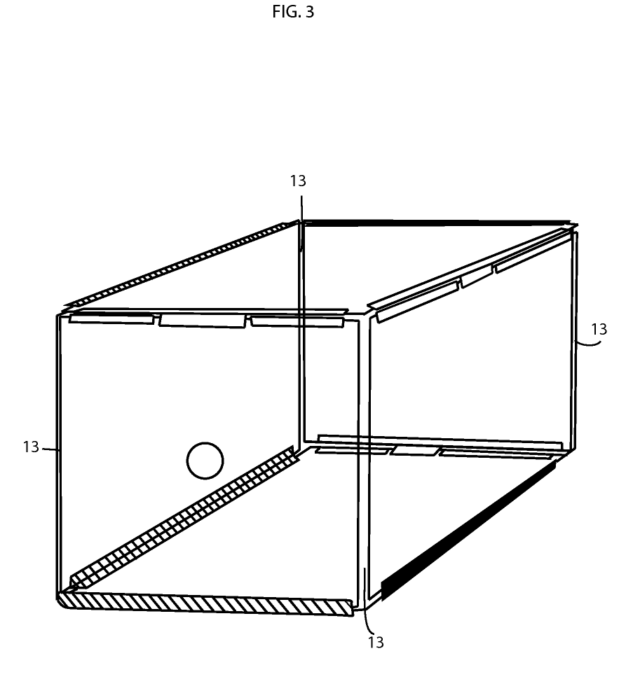

FIG. 3 shows the said chamber in its enclosed state. It also shows the gaps formed when the said chamber is in its enclosed state.

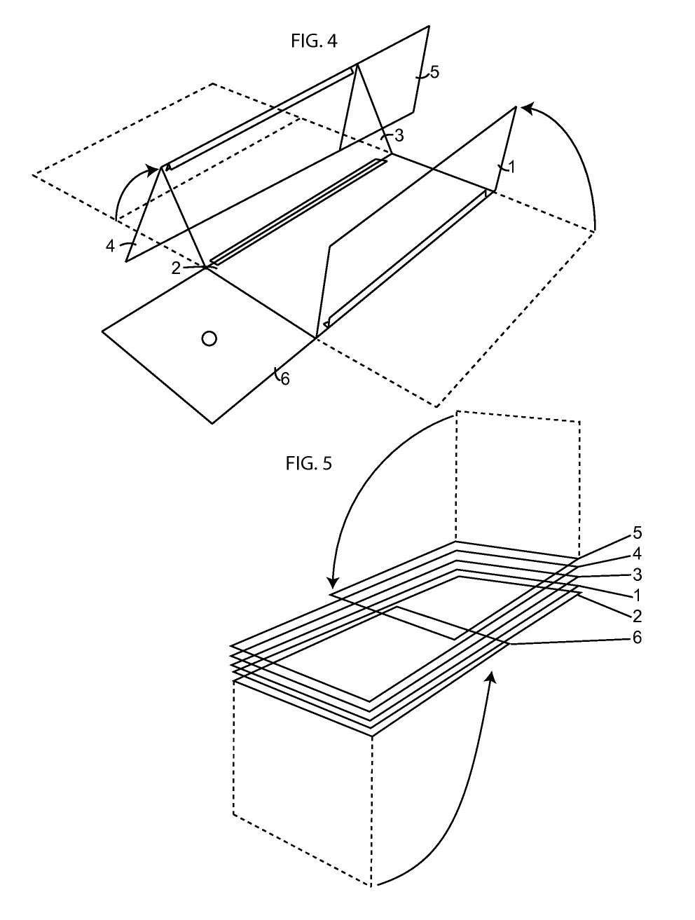

FIG. 4 shows the direction of said panels move to form the foldable said chamber.

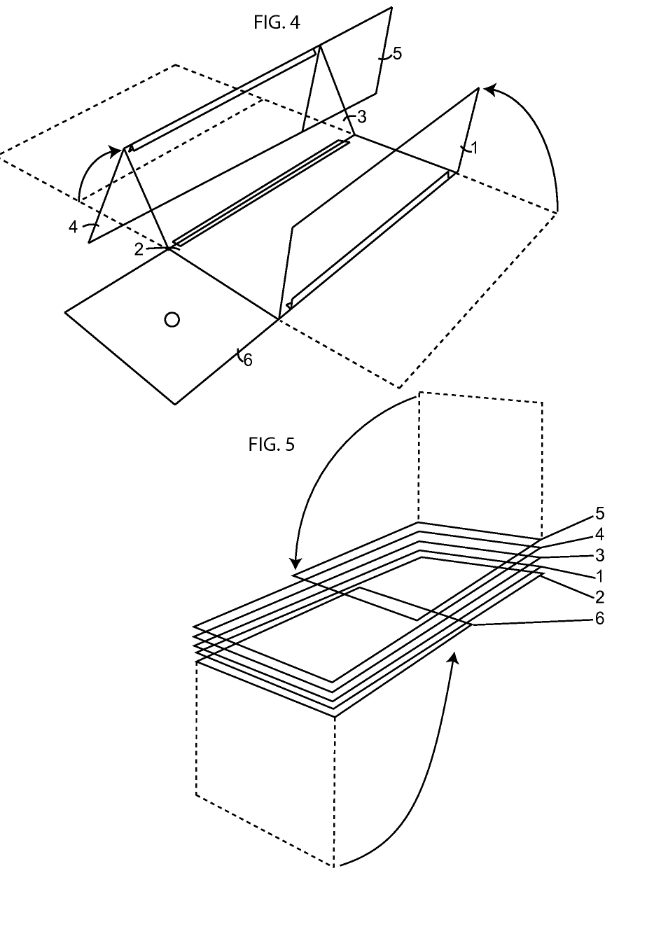

FIG. 5 shows the folded state.

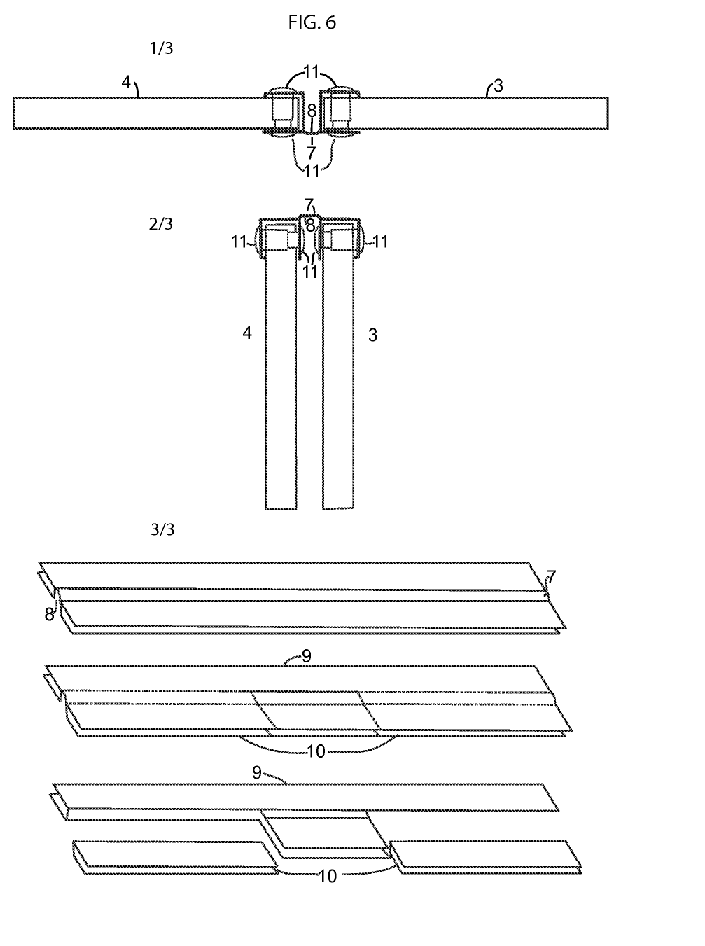

FIG. 6, 1/3, shows a vertical view of said edging with said panel, and adjoining said panel, and a screw demonstrating the joining of materials. FIG. 6, 2/3, shows a vertical view of said edging showing both sides of said edging, with its smooth side, and gully side, and the movement urged by said edging. FIG. 6, 3/3, shows a horizontal view of said edging, showing said smooth side, and said gully side. It also shows the modified edging that provides a means of said latch, and said notch.

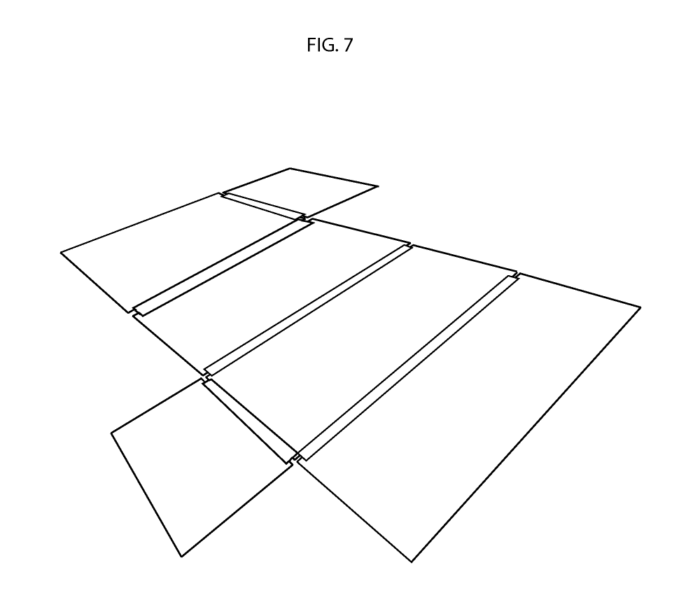

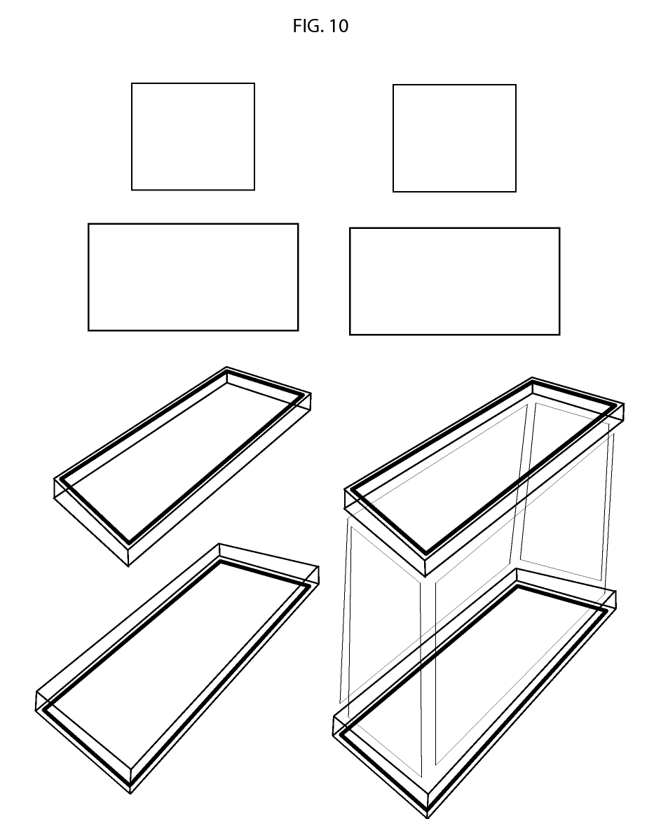

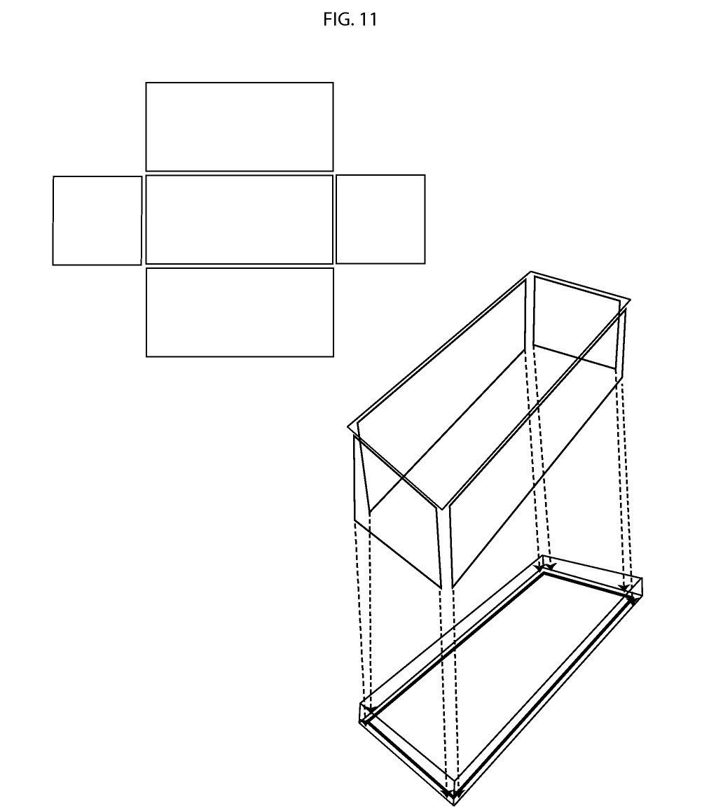

FIGS. 7, 8, 9, 10 and 11 shows said chamber, in its linear form, with various methods of comprising the chamber in accordance with other embodiments. FIGS. 10, and 11 also show the embodiment's enclosed shape.

### REFERENCE NUMERALS

1, 2, 3, 4, 5, and 6: panels

7a, 7b, 7c: smooth side of edging

8a, 8b: gully side of edging

9a, 9b, 9c: modified edging with latches

10a, 10b, 10c: modified edging with notches

11: screws

12: hole

13: gap

### DETAILED DESCRIPTION

### FIGS. 1, 2, 3, and, 4

### First Embodiment

One Embodiment of the chamber is illustrated in FIGS. 1, 2, 3, and 4. FIG. 1 shows said chamber with six sides when unfolded in its linear state. Drawing reference numbers 1, 2, 3, 4, 5, and 6 show six panels that form the body of said chamber. We contemplate the panels being made of acrylic, however other materials can be used which would be suitable.

Drawing reference numbers 7a, 7b, and 7c show the smooth side of the edging, using hatch lines through the edging. Edging within this embodiment is contemplated to be comprised of a living hinge. Any type of a flexible ligamentous joint can be used which would be suitable. Other embodiments can be used and are suitable. Since said chamber can fold in and fold out, the smooth side of the edging represents the adjoining said panels folding in. Drawing reference numbers 8a, and 8b show the gully side of said edging, using two bold lines in the drawing. The said gully side of said edging represents the adjoining said panels folding out. The operation of said edging joined to said panels can be seen in FIGS. 2, 4, and 5.

Drawing reference numbers 9a, 9b, and 9c show the latches or hasps that are joined to the said panels. Drawing reference numbers 10a, 10b, and 10c show the notches that are joined to the said panels. The said latches connect to their corresponding said notches such that latch 9a connects to notch 10a, latch 9b connects to 10b, and latch 9c connects to 10c, thus securing the chamber into place. The direction each of the said panels move can be seen in FIG. 2. The end result can be seen in FIG. 3. Other types of latches or hasps can be used to secure said panels that would be suitable. In addition, other embodiments do not require latches, or notches.

Drawing reference number 11 shows the screws used to join said edging to said panel. This embodiment shows that screws are used to join said edging to said panel. Other embodiments that do not use screws can also be used and are suitable.

Drawing reference number 12 shows a hole or orifice in one panel. This shows the entry way of standard respiratory tubing. Holes or orifices can be placed on any said panel; anywhere on said panel; which would be suitable.

FIGS. 2, 1/2 and 2/2 show the direction of movement of each said panels. Each said panel joins together to form a cube with each said edging moving in its urged and appropriate direction, and each said latch, and said notch meeting. The end product can be seen in FIG. 3.

FIG. 3 shows the said chamber in its enclosed form. Drawing reference numbers 13 show the gaps in the chamber. These said gaps allow atmospheric air to flow into said chamber, and carbon dioxide to flow out of said chamber.

FIG. 4 shows the direction of movement of said panel with its corresponding said edging, showing the folding nature. FIG. 5 shows the continuation of adjoining panels folding to a compact said foldable chamber. Drawing reference numbers 5, 4, 3, 1, 2, and 6 show the order number of said panels into its said foldable state, in this embodiment.

FIG. 6 shows various views of said edging. FIG. 6, 1/3, shows a vertical view of said edging with said panel, and a screw and post demonstrating the joining of said materials. Since all said edging (drawing reference number 7 or 8), said panels (drawing reference numbers 1, 2, 3, 4, 5, or 6), and said screws (drawing reference number 11), are connected the same way, one view representing all of said materials is shown. Said screws are contemplated to be durable plastic, however any material can be used as fasteners which would be suitable, however, they cannot be made of material that would rust or react with said materials; they cannot be made with materials that would react with medication. This figure also shows the said smooth side of said edging, and gully side of said edging.

FIG. 6, 2/3 shows a vertical view of said edging with its said smooth side and said gully side. Since said panels have a thickness associated with them, said smooth side of said edging urges inward movement, and the said gully side urges outward movement, thus enabling all the said panels to fold on top of each other.

FIG. 6, 3/3, shows a horizontal view of said edging with its said smooth side and said gully side. It also shows said edging modified to create said latch, and said notch. The dotted line represents a cut in said edging which creates said latch, and said notch. The center spine of said edging is discarded after cuts are made.

### FIGS. 7, 8, 9, 10 and 11

### Alternative Embodiments

Additional embodiments are shown in FIGS. 7, 8, 9, 10 and 11; In FIG. 7 all of the edging are either heat-sealed or adhered to each of the panels, eliminating the need to drill holes and use screws to connect each edging to each panel, thus producing a flexible ligamentous joint in order to fold each panel onto adjacent panels.

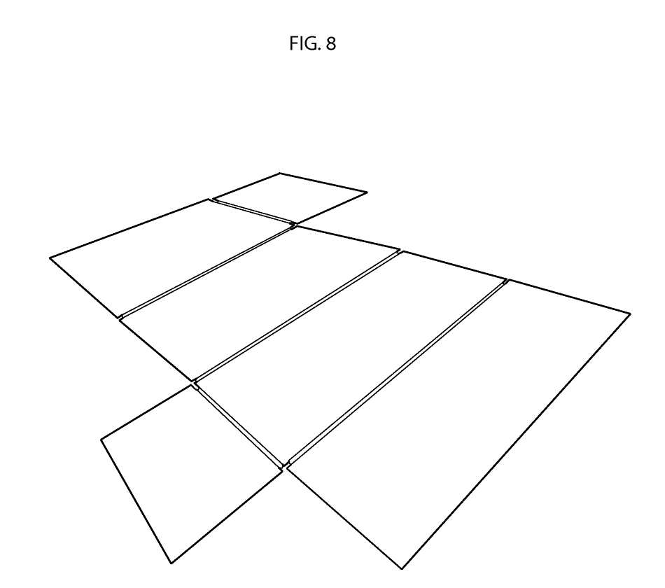

In FIG. 8 the entire said chamber is extruded in one piece eliminating the need for separate said edging, eliminating the need for any screws, thus producing a flexible ligamentous joint in order to fold each panel onto adjacent panels producing a said foldable chamber or cube.

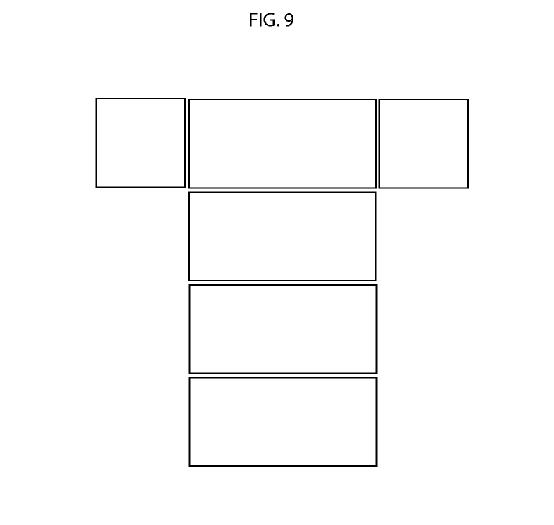

In FIG. 9 two of the said panels are joined to the same said panel forming one contiguous piece. This embodiment can be comprised with edging and screws. It is contemplated that it can also be extruded which eliminates the said edging, and said screws.

In FIG. 10 two of the said panels are contemplated to have said edging as part of the panel to secure the other said panels into. The edging can be heat-sealed, adhered, or screwed onto said panel. Said edging, and said panel can also be extruded as one piece. One said panel is contemplated as a bottom or tray. One said panel is contemplated as a top which would secure the entire said chamber.

In FIG. 11 one of the said panels is contemplated to have said edging as part of the panel to secure the other said panels into. The edging can be heat-sealed, adhered, or screwed onto said panel producing a flexible ligamentous joint. Said edging, and said panel can be extruded as one piece producing a flexible ligamentous joint. This said panel is contemplated to be the bottom, or top of the said chamber. The remaining five said panels are contemplated to be comprised of said edging, and said screws, or just said edging being heat-sealed or adhered to said panel producing a flexible ligamentous joint. The remaining said panels can also be contemplated as being extruded as one contiguous piece producing a flexible ligamentous joint.

All Embodiments can have a voluminous variation of latch types. The first embodiment shows latch as modified edging, and a notch as modified edging, however, any type of enclosure method can be used and would be suitable, as long as it does not react with medication, or rusts, or reacts with other said materials. The embodiments in FIG. 10, and FIG. 11 would not require any latches, or notches since the said top and said bottom in FIG. 10, and the top or bottom in FIG. 11, would secure said chamber into place.

We claim:

1. A foldable respiratory therapy chamber for small animals comprising:

2. The chamber of claim 1 wherein said body of materials is comprised of a plurality of transparent panels.

3. The chamber of claim 1 wherein said body of materials is comprised of a plurality of edging.

4. The chamber of claim 1 wherein said body is comprised of a means that a human operator can fold said body into a stack of said adjacent panels.

5. The chamber of claim 1 wherein said body is comprised of a means that a human operator can unfold said body into a stable chamber.

6. The chamber of claim 1 wherein said body of materials is comprised of a means for atmospheric air to flow into said chamber, and carbon dioxide to flow out of said chamber whereby carbon dioxide does not build up in said chamber.

7. The chamber of claim 1 wherein said body of materials is comprised of a means to use standard respiratory apparatus.
